(19) United States
(12) Patent Application Publication
(10) Pub. No.: US 2025/0210922 A1
(43) Pub. Date: Jun. 26, 2025

(54) DUAL-SIDED CONNECTOR FOR CONNECTING A SIGNAL CABLE TO A FLOATING HARDWARE COMPONENT AND ASSOCIATED METHOD

(71) Applicant: Hewlett Packard Enterprise Develolpment LP, Spring, TX (US)

(72) Inventors: Rachid Kadri, Houston, TX (US); Michael Chan, Houston, TX (US)

(21) Appl. No.: 18/390,636

(22) Filed: Dec. 20, 2023

(51) Int. Cl. H01R 13/73; H01R 31/06

(52) U.S. Cl. CPC H01R 13/73; H01R 31/06

(57) ABSTRACT

In certain implementations, a connector includes a housing; a first socket on a first side of the housing, the first socket configured to receive a first signal cable connector inserted into the first socket; and a second socket on a second side of the housing, the second socket configured to receive an end portion of a hardware component inserted into the second socket. The first socket and the second socket are adjacent to each other, and have openings that are interconnected with each other. The connector includes a first metal contact extending along a first surface of the first socket to along a corresponding first surface of the second socket, and includes a second metal contact extending along a second surface of the first socket to along a corresponding second surface of the second socket.

### BACKGROUND

Computers typically include one or more signal transmission cables for transmitting signals between a motherboard of the computer and one or more hardware components separate from the motherboard, such as one or more expansion or add-on cards. Peripheral component interconnect express (PCIe) is an interface standard for connecting high-speed input output (HSIO) devices. Typically, the number and orientation of PCIe devices (e.g., PCIe cards) connected to a motherboard of a computer can be adjusted using one or more riser cards. Some computer designs include compatibility with open compute project (OCP) cards in addition to or in place of PCIe devices.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1A-1E illustrate an example of a dual-sided connector for connecting a signal cable to a floating hardware component for signal transmission, and in which the floating hardware component is a PCIe Add-in card, according to certain implementations;

FIGS. 2A-2F illustrate an example of a dual-sided connector for connecting a signal cable to a floating hardware component for signal transmission, and in which the floating hardware component is an OCP card, according to certain implementations; and

FIG. 3 illustrates an example method for a dual-sided connector for connecting a signal cable to a hardware component for signal transmission, according to certain implementations.

### DETAILED DESCRIPTION

To transmit signals between a motherboard of a computer and one or more hardware components (e.g., PCIe cards), the hardware components may be plugged into expansion slots on the motherboard. However, the number of hardware components that can be plugged into the motherboard may be limited by the space and number of expansion slots available on the motherboard. Additionally or alternatively, the orientation of each of the hardware components may be fixed relative to the motherboard. For example, PCIe cards may be designed to be inserted into the motherboard in a specific direction, potentially limiting flexibility during installation. Using the PCIe cards in conjunction with a riser card, where cable wires might be soldered directly to the PCIe connector pins of the riser card, might allow the PCIe cards to be located some distance away from the motherboard. However, this implementation may result in reduced signal transmission quality due to an increased number of impedance discontinuities such as from connector pin pads and conductive material (e.g., copper, or the like). Additionally or alternatively, with such soldered solutions, both the cable wires and the riser card may have to be replaced in case of damage or electrical problems to either the cable wires or the riser card, which may increase operational costs. Certain implementations of this disclosure provide a dual-sided connector that may improve signal transmission quality of signals transmitted between hardware components in a computer system and/or may increase flexibility during installation of hardware components. The structure and the operation of the dual-sided connector is described in more detail below in multiple scenarios.

Certain implementations of this disclosure provide the dual-sided connector that provides for the transmission of signals from a first side of the dual-sided connector to a second side of the dual-sided connector. The dual-sided connector may include metal contacts that extend through a housing of the dual-sided connector. The contiguous metal contacts extend from a first socket on the first side of the dual-sided connector to a second socket on the second side of the dual-sided connector.

In certain implementations, the dual-sided connector may be used as a conduit to transmit signals between a fixed hardware component that is connected to the first socket via a signal transmission cable, and a floating hardware component that is plugged into the second socket of the dual-sided connector. The fixed hardware component may be a physical component, such as a computer motherboard, in a computer that is permanently (or semi-permanently) attached to the computer. The dual-sided connector and the signal transmission cable can be used to allow the floating hardware component to be located some distance (and potentially a relatively significant distance) away from the fixed hardware component, and disposed in any orientation relative to the fixed hardware component. The floating hardware component refers to a component that is not permanently attached to the computer, but that can be added or removed from the second socket of the dual-sided connector.

This disclosure describes examples of the dual-sided connector being used in conjunction with various fixed hardware components and floating hardware components. In certain examples, the fixed hardware component is a computer motherboard, and the floating hardware component is a PCIe Add-in card. In certain examples, the fixed hardware component is a computer motherboard, and the floating hardware component is an OCP card. The described fixed hardware components and the floating hardware components are provided as examples only.

Taking a PCIe Add-in card as a first example of a floating hardware component, the number and orientation of PCIe devices (e.g., PCIe cards) connected to a motherboard of a computer may be adjusted using one or more riser cards. A riser card may be a printed circuit board (PCB) that allows additional PCIe devices to be added to a computer's motherboard. Example types of riser card design solutions include a fixed riser card and a floating riser card. A fixed riser card may be plugged into a riser card connector located on the main system board (e.g., close to the root complex device). A floating riser card may use cables as the main interconnect between the root complex device and the riser card, where the root complex device may be located some distance (and potentially a relatively significant distance) from the riser card. Ever increasing performance requirements/targets lead designers to seek solutions that deliver higher PCIe bus speeds as well as improved signal quality, at the lowest possible manufacturing cost.

In certain implementations, the dual-sided connector of this disclosure can be used in conjunction with a riser card. The riser card (e.g., a floating riser card) may be located some distance (and potentially a relatively significant distance) from the root complex device of a computer motherboard. The dual-sided connector may allow a PCIe cable that is connected to the computer motherboard to be plugged into a first side of the dual-sided connector and a PCIe Add-in card to be plugged into a second side of the dual-sided connector. The dual-sided connector may facilitate transmitting signals between the PCIe Add-in card and the computer motherboard. The dual-sided connector may include one or more contiguous metal contacts that are configured to be in contact with a signal pad of the PCIe cable when the PCIe cable is plugged into the first side of the dual-sided connector. In addition, the one or more contiguous metal contacts may be configured to be in contact with a signal pad of the PCIe card edge connector when the PCIe Add-in card is plugged into the second side of the dual-sided connector. The metal contact may act as a bridge between the two signal pads, allowing transmission of signals between the two signal pads.

In certain implementations, the dual-sided connector allows a PCIe cable to be removably attached to a riser card, which may reduce manufacturing and assembly costs relative to solutions that involve fixedly attaching the PCIe cable to a riser card, while still providing for adequate or even improved bus speeds and signal quality. In certain implementations, both the PCIe cable and the riser card are separable from each other by simply unplugging them from the dual-sided connector, which may allow replacement of either the PCIe cable or the riser card (e.g., in case of damage or electrical problems) without replacing both the PCIe cable and the riser card, which may reduce costs such as cable wires directly soldered to the PCIe connector pins. The dual-sided connector may improve signal transmission quality due to a reduced number of impedance discontinuities such as from connector pin pads, and conductive (e.g., copper or another suitable metal material). In certain implementations, different lengths of PCIe cable may be utilized to connect the computer motherboard to the dual-sided connector, allowing for flexibility in the positioning of the riser card relative to the root complex device of the motherboard.

Taking an OCP card as another example of a floating hardware component, certain implementations of this disclosure provide a dual-sided connector that can be used to provide a floating OCP slot that includes the dual-sided connector. The dual-sided connector may be configured to allow an OCP card to be plugged into the second side of the dual-sided connector. The dual-sided connector may be coupled to and supported in position by a support structure disposed within a chassis of the computer. The dual-sided connector allows for transmitting signals between the OCP card and the computer motherboard. The dual-sided connector may include one or more contiguous metal contacts configured to be in contact with a signal pad of the PCIe cable when the PCIe cable is plugged into the first side of the dual-sided connector. The one or more contiguous metal contacts may be configured to be in contact with a signal pad of the OCP card edge connector when the OCP card is plugged into the second side of the dual-sided connector. The one or more metal contacts may act as a bridge between the two signal pads, allowing transmission of signals between the two signal pads.

In certain implementations, one or more similar advantages to those described above for the implementation of the riser card and the dual-sided connector that allow the PCIe cable to be plugged into the first side of the dual-sided connector, and a PCIe Add-in card to be plugged into the second side of the dual-sided connector, also apply to the implementation of the floating OCP slot and the dual-sided connector that allow the PCIe cable to be plugged into the first side of the dual-sided connector, and the OCP card to be plugged into the second side of the dual-sided connector.

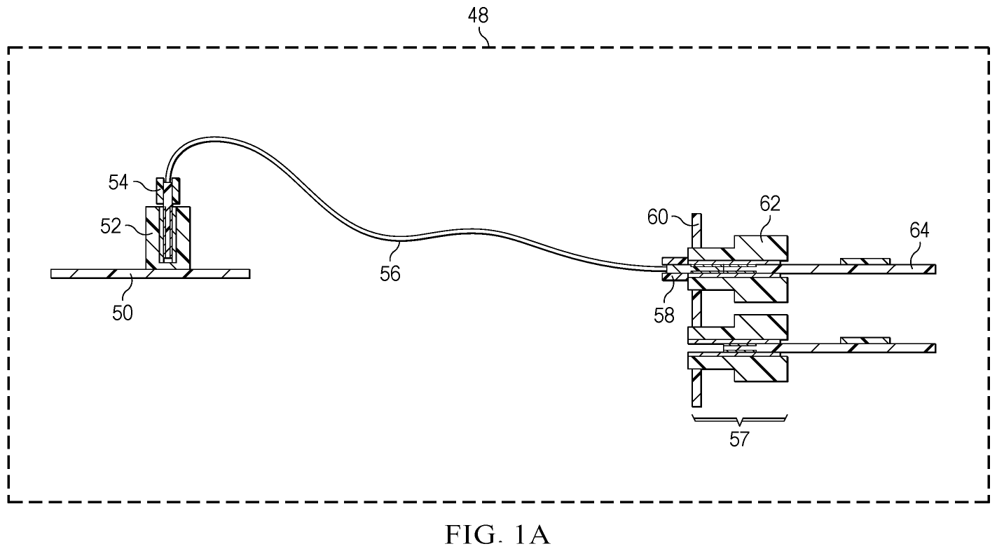

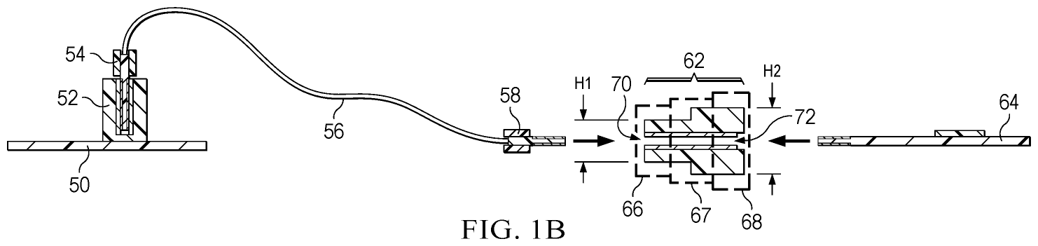

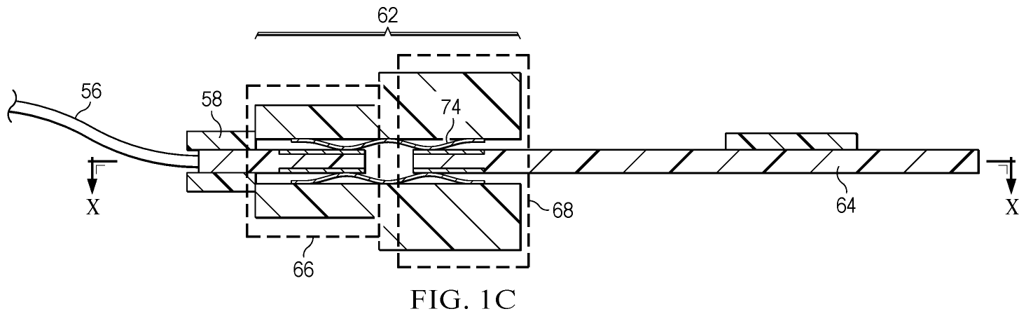

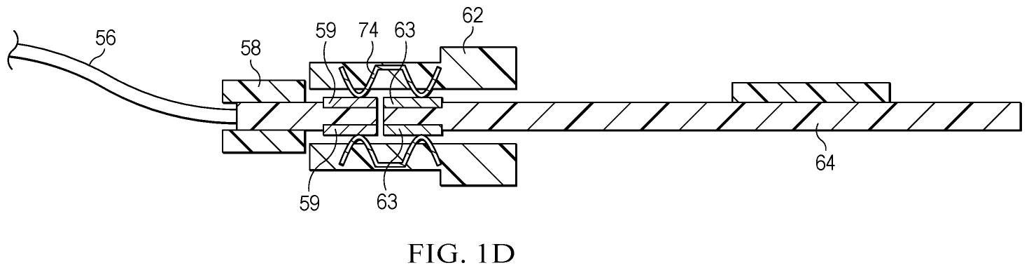

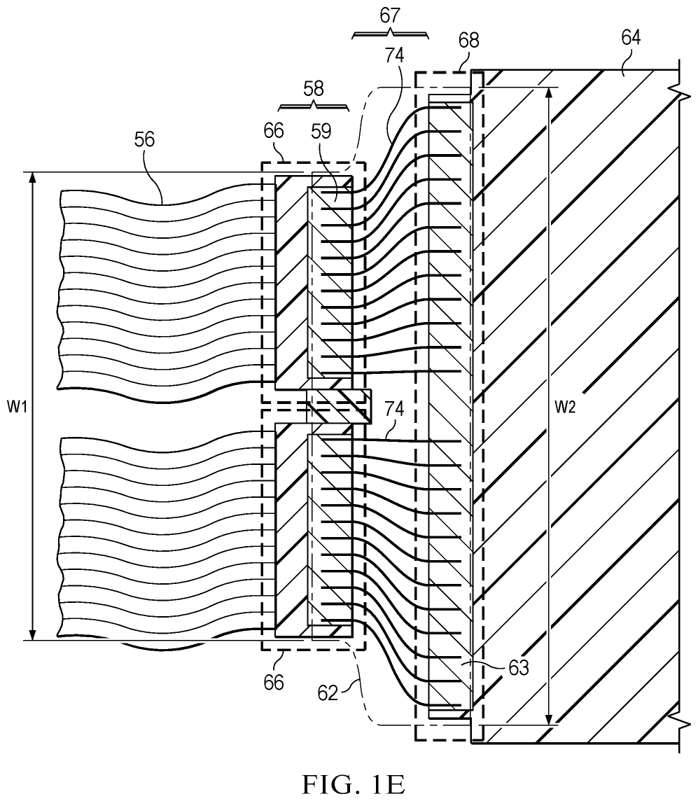

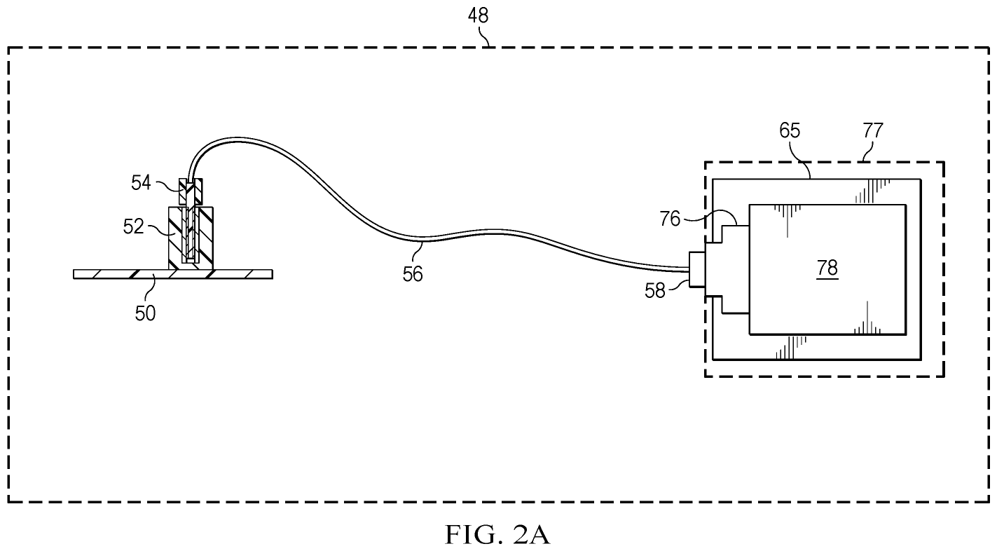

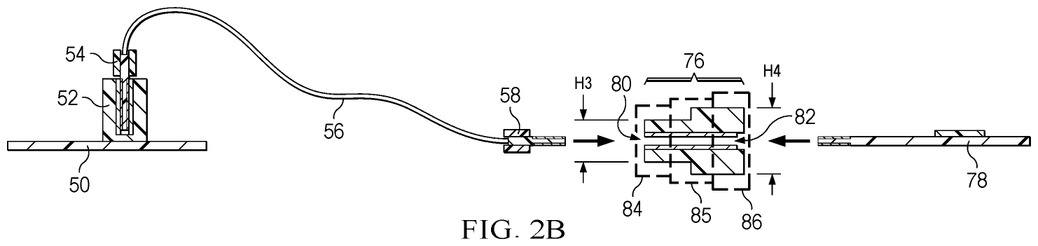

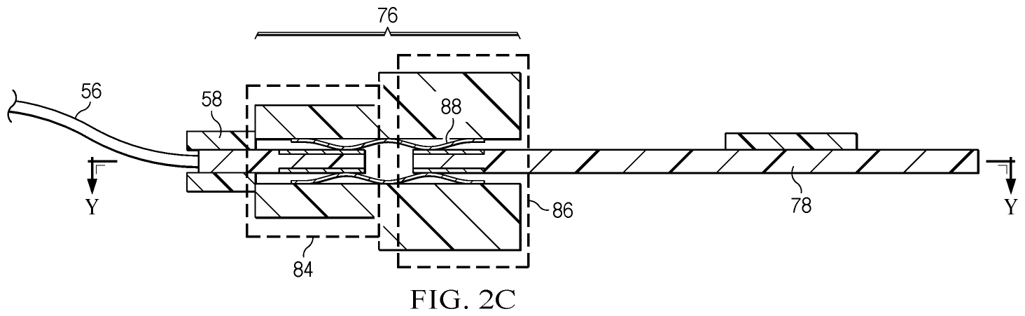

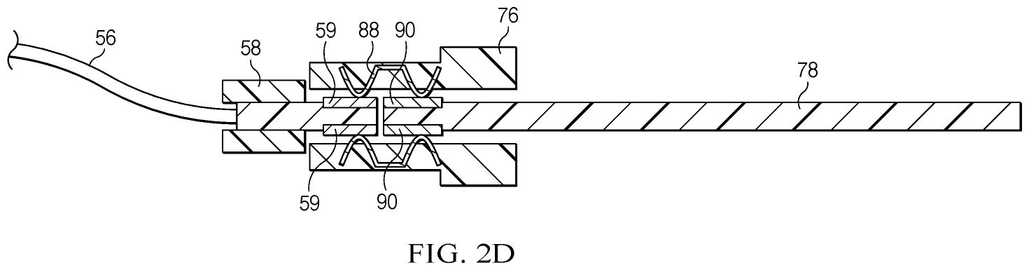

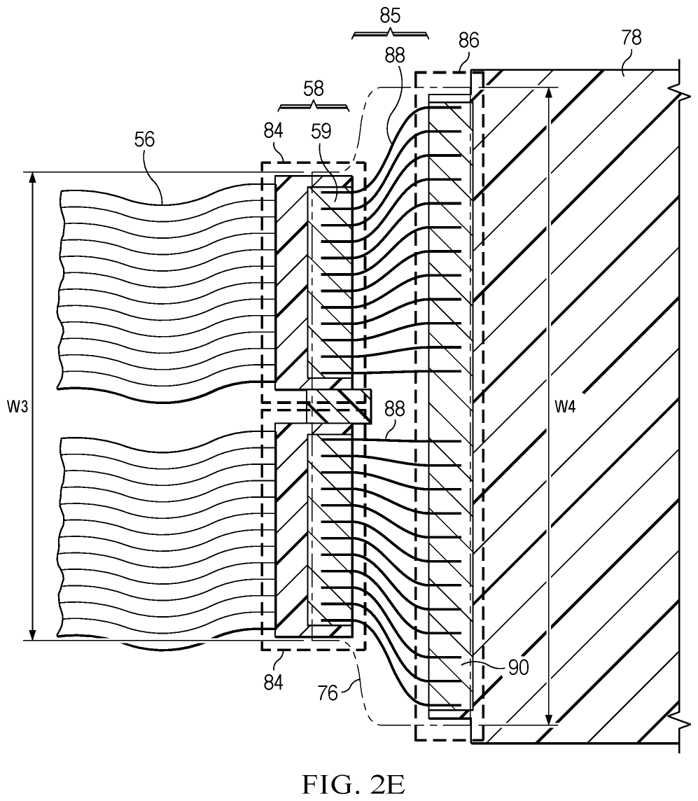

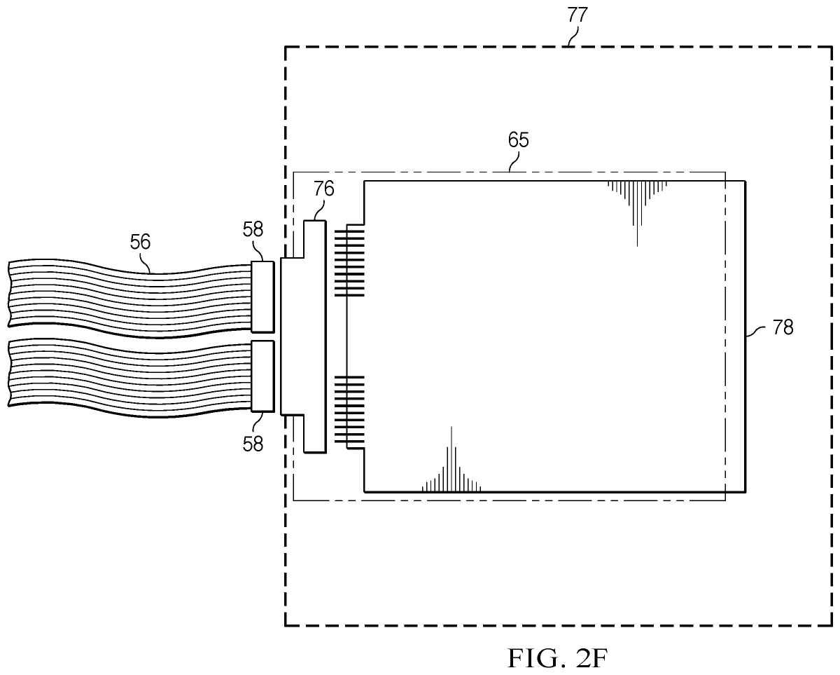

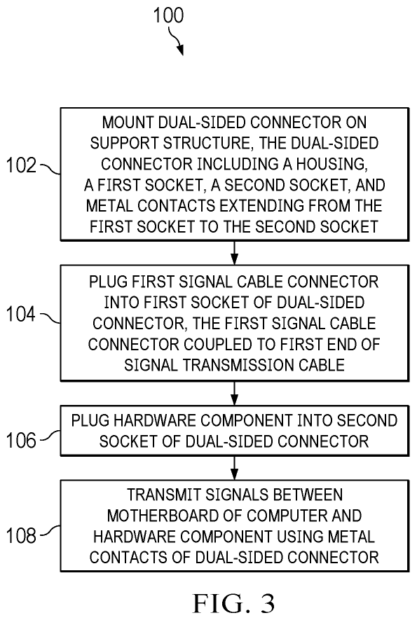

Turning to the figures, FIGS. 1A through 1E illustrate an example application of the dual-sided connector in which a fixed hardware component is a computer motherboard and a floating hardware component is a PCIe Add-in card. FIGS. 2A through 2F illustrate an example application of the dual-sided connector in which a fixed hardware component is a computer motherboard and a floating hardware component is an OCP card. FIG. 3 illustrates a flowchart that describes a method for implementing the dual-sided connector together with a fixed hardware component and a floating hardware component. Each figure is described in greater detail below. Throughout the following description, unless specified otherwise, like reference numerals may represent like components in the various figures such that the description of those components might not be repeated.

FIG. 1A illustrates an example computer that includes a dual-sided connector for connecting a signal cable to a hardware component for signal transmission, according to certain implementations. In particular, FIG. 1A illustrates a riser card configuration example in which the dual-sided connector is used in conjunction with a riser card.

In certain implementations, the components of FIG. 1A may be disposed within a chassis of a computer 48. Computer 48 may be any suitable type of electronic processing device, including, as particular examples, a desktop computer or a computer server. A riser card configuration refers to the use of one or more hardware components that include a riser card that is used to change the physical layout or orientation of Add-in cards (also referred to as expansion cards) within a computer chassis. Add-in cards are hardware components or devices that can be added to a computer's motherboard to enhance its capabilities. Add-in cards may include graphics cards, network cards, sound cards, other peripherals, or the like. Example Add-in cards may be PCIe-compatible and may be referred to as PCIe cards or PCI Add-in cards.

A motherboard 50 may be disposed within the chassis of computer 48, and a central processing unit (CPU) may be securely mounted on motherboard 50. In addition, storage drives, such as solid-state drives (SSDs), hard disk drives (HDDs), or the like, may be mounted within the chassis of computer 48.

In the example of FIG. 1A, the riser card configuration includes a floating riser card 57 that includes a riser card body 60, and a dual-sided connector 62. Floating riser card 57 allows the use of one or more signal transmission cables (e.g., a PCIe cable 56) as the main interconnect to connect to the root complex device of motherboard 50 of computer 48, where the root complex device may be located some distance (and potentially a relatively significant distance) from floating riser card 57. Riser card body 60 may include a PCB and may be supported in position within the chassis of computer 48 using any suitable support structure. For example, the support structure may be a mechanical structure, such as a tray, a plate, a mounting bracket, a mounting adapter, or the like. In addition, PCIe cable 56 may have any desired length, potentially provided that the PCIe cable 56 remains within the specifications for signal integrity, if appropriate. PCIe cable 56 may be coupled to a first PCIe plug 54 (which also may be referred to subsequently as a connector, signal cable connector, or PCIe cable connector) at a first end of PCIe cable 56, and to a second PCIe plug 58 (which also may be referred to subsequently as a connector, signal cable connector, or PCIe cable connector) at a second end of PCIe cable 56. First PCIe plug 54 may be plugged into a PCIe connector 52 (which also may be referred to subsequently as a slot or a socket) coupled to motherboard 50. Second PCIe plug 58 may be plugged into a first socket 66 of dual-sided connector 62.

Dual-sided connector 62 may be supported by and extend through riser card body 60. Dual-sided connector 62 also may be referred to as a signal transmission device. Dual-sided connector 62 may include a housing 67 (shown subsequently in FIG. 1B), first socket 66 (shown subsequently in FIG. 1B) on a first side of housing 67, and a second socket 68 (shown subsequently in FIG. 1B) on a second side of housing 67. First socket 66 is adapted to receive second PCIe plug 58 inserted into first socket 66 of dual-sided connector 62. That is, first socket 66 is adapted to allow second PCIe plug 58 to be plugged into first socket 66 of dual-sided connector 62. Second socket 68 is adapted to receive an end portion of a PCIe Add-in card 64 inserted into second socket 68 of dual-sided connector 62. That is, the second socket 68 is adapted to allow a PCIe Add-in card 64 to be plugged into second socket 68 of dual-sided connector 62.

When second PCIe plug 58 is plugged into first socket 66 and PCIe Add-in card 64 is plugged into second socket 68, dual-sided connector 62 allows transmitting of signals between PCIe Add-in card 64 and motherboard 50. The signals may include data signals, control signals, power signals, and/or any other suitable type of signals. In certain implementations, more than one dual-sided connector 62 may extend through riser card body 60. In such a case, more than one PCIe Add-in card 64 may be connected to motherboard 50. Each PCIe Add-in card 64 is connected to motherboard 50 using a corresponding dual-sided connector 62 and a corresponding PCIe cable 56, wherein PCIe Add-in card 64 is plugged into second socket 68 of the corresponding dual-sided connector 62, and second PCIe plug 58 of the corresponding PCIe cable 56 is plugged into first socket 66 of the corresponding dual-sided connector 62.

FIG. 1B illustrates additional details of the example dual-sided connector 62 of FIG. 1A and its associated operation, according to certain implementations. Riser card body 60 is omitted from FIG. 1B for purposes of clarity. Dual-sided connector 62 may include housing 67 (which also may be referred to subsequently as the body), first socket 66 (which may also be described subsequently as a receptacle) on a first side of housing 67, and second socket 68 (which may also be described subsequently as a receptacle) on a second side of housing 67, wherein the first side is on an opposite side of housing 67 as the second side of housing 67.

First socket 66 may include a first opening 70, and second socket 68 may include a second opening 72. First socket 66 is adapted to allow second PCIe plug 58 to be inserted into the first opening 70 of first socket 66, and second socket 68 is adapted to allow an end portion of PCIe Add-in card 64 (e.g., a PCIe card edge connector of PCIe Add-in card 64) to be inserted into second opening 72 of second socket 68. First opening 70 and second opening 72 are adjacent to each other, and are interconnected with each other. In certain implementations, first opening 70 and second opening 72 form at least part of a continuous opening that also extends through housing 67 of dual-sided connector 62.

Dual-sided connector 62 may include contiguous metal contacts 74 (shown subsequently in FIG. 1C) that are configured to be in contact with a signal pad of second PCIe plug 58 when second PCIe plug 58 is plugged into first socket 66 of dual-sided connector 62. In addition, contiguous metal contacts 74 are configured to be in contact with a signal pad of the PCIe card edge connector of PCIe Add-in card 64 when PCIe Add-in card 64 is plugged into second socket 68 of dual-sided connector 62. Each metal contact 74 therefore acts as a bridge between the two signal pads. Dual-sided connector 62 therefore allows signal transmission between PCIe Add-in card 64 and PCIe cable 56.

Dual-sided connector 62 may include portions having different heights. For example, a first portion of dual-sided connector 62 that includes first socket 66 may have a first height H1. A second portion of dual-sided connector 62 that includes second socket 68 may have a second height H2, wherein the height H1 is different from the height H2. In certain implementations, the height H2 is greater than the height H1.

FIGS. 1C-1E illustrate additional details of dual-sided connector 62 of FIGS. 1A and 1B, according to certain implementations. In particular, FIGS. 1C-1D illustrate a state of dual-sided connector 62 after second PCIe plug 58 is plugged into first opening 70 of first socket 66, and the PCIe card edge connector of PCIe Add-in card 64 is plugged into second opening 72 of second socket 68. FIG. 1E shows a top-down view of dual-sided connector 62 along a cross-section X-X that is shown in FIG. 1C. In FIGS. 1C-1E, riser card body 60 is omitted for purposes of clarity.

FIGS. 1C-1D show that dual-sided connector 62 may include contiguous metal contacts 74. Metal contacts 74 may include a conductive material (e.g., copper, copper alloy, or any other suitable conductive material) and may extend along a first surface of first socket 66 to along a corresponding first surface of second socket 68, and along a second surface of first socket 66 to along a corresponding second surface of second socket 68. In certain implementations, the first surface of first socket 66 is a top surface in first opening 70, and the first surface of second socket 68 is a top surface in second opening 72. In certain implementations, the second surface of first socket 66 is a bottom surface in first opening 70, and the second surface of second socket 68 is a bottom surface in second opening 72.

First opening 70 and second opening 72 form at least part of a continuous opening that also extends through housing 67 of dual-sided connector 62, and as such, each metal contact 74 that extends along the first surface of first socket 66 to along the corresponding first surface of second socket 68 also extends along a top surface of a first portion of the continuous opening that is disposed between first opening 70 and second opening 72. Additionally, each metal contact 74 that extends along the second surface of first socket 66 to along the corresponding second surface of second socket 68 also extends along a bottom surface of the first portion of the continuous opening that is disposed between first opening 70 and second opening 72.

Each metal contact 74 may be elongated, and may include a strip having a rectangular or cylindrical cross-section. In certain implementations, metal contacts 74 may be arranged to be flat. In certain implementations, metal contacts 74 may be arranged to have a zigzag form (e.g., as shown in FIGS. 1C and 1D) that includes multiple bends or turns in the metal, with first portions of each metal contact 74 being embedded in the walls of first socket 66, second socket 68, and housing 67.

Second portions of each metal contact 74 may extend into first opening 70, second opening 72, or the first portion of the continuous opening that is disposed between first opening 70 and second opening 72. Second portions of each metal contact 74 that extend into first opening 70 may be adapted to make physical and electrical contact with a first signal pad 59 of second PCIe plug 58 when second PCIe plug 58 is plugged into first opening 70 of first socket 66. Portion of each metal contact 74 that extend into second opening 72 may be adapted to make physical contact and electrical contact with a first signal pad 59 and with a second signal pad 63. of the PCIe card edge connector of PCIe Add-in card 64, when PCIe Add-in card 64 is plugged into second opening 72 of second socket 68.

Metal contacts 74 that extend along the first surface of first socket 66 to along the corresponding first surface of second socket 68 are adapted to be vertically above, and make physical and electrical contact with a top surface of a top portion of first signal pad 59 of second PCIe plug 58, and a top surface of a top portion of second signal pad 63 of the PCIe card edge connector. Metal contacts 74 that extend along the second surface of first socket 66 to along the corresponding second surface of second socket 68 are adapted to be vertically below, and make physical and electrical contact with a bottom surface of a bottom portion of first signal pad 59 of second PCIe plug 58, and a bottom surface of a bottom portion of second signal pad 63 of the PCIe card edge connector.

Metal contacts 74 may be arranged to have the zigzag form (e.g., as shown in FIGS. 1C and 1D) that includes multiple bends or turns in the metal-to provide a secure and reliable electrical connection between first signal pad 59 and second signal pad 63 via metal contacts 74. In addition, the multiple bends or turns in the metal may be strategically positioned to ensure proper alignment and a snug fit of second PCIe plug 58 in first opening 70 of first socket 66, and the PCIe card edge connector of PCIe Add-in card 64 in second opening 72 of second socket 68. For example, the multiple bends or turns in the metal may be strategically positioned to ensure proper alignment and a snug fit to accommodate different width PCIe cable plug 58 and the PCIe card edge connector of PCIe Add-in card 64. When second PCIe plug 58 is plugged into first socket 66, and the PCIe card edge connector of PCIe Add-in card 64 is plugged into second socket 68, signals may be transmitted between motherboard 50 and PCIe Add-in card 64 through PCIe cable 56, first signal pad 59, metal contacts 74, and second signal pad 63.

In certain implementations, dual-sided connector 62 may include more than one of first sockets 66 on the first side of dual-sided connector 62. For example, FIG. 1E shows dual-sided connector 62 including first sockets 66 (e.g., two of first sockets 66). Dual-sided connector 62 also includes second socket 68, and housing 67 disposed between first sockets 66 and second socket 68. An edge of dual-sided connector 62 that is disposed on the first side (e.g., including first sockets 66) of dual-sided connector 62 may have a first width W1. Second socket 68 is disposed on the second side of housing 67, wherein an edge of dual-sided connector 62 that is disposed on the second side of dual-sided connector 62 may have a second width W2. In certain implementations, the first width W1 is different from the second width W2. In certain implementations, the second width W2 is greater than the first width W1. As shown in FIG. 1E, each first socket 66 may be electrically connected to motherboard 50 by a corresponding PCIe cable 56, wherein each PCIe cable 56 is coupled to the respective first socket 66 by a respective second PCIe plug 58 that is plugged into the respective first socket 66.

Two of first sockets 66 are shown in FIG. 1E, wherein each first socket 66 may be designed to accommodate, as just one example, a PCIe x8 cable. Therefore each PCIe cable 56 may be a PCIe x8 cable (which may also be referred to as a PCI Express x8 cable), which is a high-speed signal transfer cable designed to connect PCIe devices, such as expansion cards, to a computer's motherboard. The “x8” designation indicates that the cable supports eight PCIe lanes for signal transmission. In other implementations, each first socket 66 may be designed to accommodate any suitable configuration of cable that supports any number of PCIe lanes for signal transmission.

Second socket 68 on the second side of dual-sided connector 62 may be designed to accommodate, as just one example, a PCIe x16 card. Therefore, PCIe Add-in card 64 may be a PCIe x16 card and second socket 68 is designed to provide sixteen individual PCIe lanes for signal transfer.

FIG. 1E also shows that each second PCIe plug 58 that is coupled to a PCIe cable 56 may include a first signal pad 59 that is electrically coupled to second signal pad 63 of PCIe Add-in card 64 using a respective set of one or more metal contacts 74. First end portions of metal contacts 74 of the respective set of one or more metal contacts 74 align with and physically contact a first signal pad 59 of a respective second PCIe plug 58, when the respective second PCIe plug 58 is plugged into a respective first socket 66. Second end portions of metal contacts 74 of the respective set of one or more metal contacts 74 align with and physically contact second signal pad 63 of the PCIe card edge connector of PCIe Add-in card 64, when the PCIe card edge connector of PCIe Add-in card 64 is plugged into second socket 68. In this way, the transmission of signals between PCIe Add-in card 64 and each PCIe cable 56 can take place using the respective set of one or more metal contacts 74.

The first width W1 of an edge of dual-sided connector 62 that is disposed on the first side of dual-sided connector 62 may be different from the second width W2 of an edge of dual-sided connector 62 that is disposed on the second side of dual-sided connector 62 (as seen in FIG. 1E). To accommodate for this variation between the first width W1 and the second width W2, the respective set of one or more metal contacts 74 that electrically connect second signal pad 63 to a respective first signal pad 59 may be disposed having different shapes (as seen in a top-down view) to ensure proper alignment of metal contacts 74, as well as to ensure correct electrical connection between second signal pad 63 and respective first signal pad 59. One or more of metal contacts 74 may have an S-shape (e.g., as shown in FIG. 1E), an L-shape, or the like. In certain implementations, one or more of metal contacts 74 may be diagonal (e.g., disposed to be at an angle relative to the edge of dual-sided connector 62 that is disposed on the second side of dual-sided connector 62), or straight (e.g., disposed to be perpendicular to the edge of dual-sided connector 62 that is disposed on the second side of dual-sided connector 62).

Certain implementations may provide none, some, or all of the following technical advantages. These and other potential technical advantages may be described elsewhere in this disclosure, or may otherwise be readily apparent to those skilled in the art based on this disclosure.

In certain implementations, dual-sided connector 62 may be used in conjunction with floating riser card 57, and may be supported by and extend through riser card body 60. Floating riser card 57 may be located some distance (and potentially a relatively significant distance) from the root complex device of motherboard 50 of computer 48. Floating riser card 57 may include a dual-sided connector 62, which may allow second PCIe plug 58 that is coupled to PCIe cable 56 to be plugged into first socket 66 on the first side of dual-sided connector 62, and PCIe Add-in card 64 to be plugged into second socket 68 on the second side of dual-sided connector 62. PCIe cable 56 also may be connected to motherboard 50.

Certain implementations may allow PCIe cable 56 to be removably attached to a riser card, as PCIe cable 56 may be removably attached to dual-sided connector 62 through engagement of second PCIe plug 58 and first socket 66 on the first side of dual-sided connector 62. Relative to a solution that would fixedly attach an end of a PCIe cable to a riser card within the chassis of a computer, using dual-sided connector 62 may reduce manufacturing and assembly costs, permit replacement of the PCIe cable and/or dual-sided connector 62 individually, and/or increase installation flexibility. Furthermore, in certain implementations, dual-sided connector 62 may provide one or more of these advantages while still providing for adequate or even improved bus speeds and signal quality.

For example, both PCIe cable 56 and floating riser card 57 may be separable from each other by simply unplugging PCIe cable 56 from dual-sided connector 62 (e.g., by removing second PCIe plug 58 from first socket 66 of dual-sided connector). This may allow replacement of PCIe cable 56 and/or floating riser card 57 (e.g., in case of damage or electrical problems or for any other reason) without replacing both PCIe cable 56 and floating riser card 57, which may reduce costs relative to other potential solutions such as cable wires directly soldered to the PCIe connector pins. In certain implementations, dual-sided connector 62 may improve signal transmission quality due to a reduced number of impedance discontinuities such as from connector pin pads and cable wires. In certain implementations, depending on what may be appropriate for a given implementation, different lengths of PCIe cable 56 may be utilized to connect motherboard 50 of computer 48 to dual-sided connector 62, allowing for flexibility in the positioning of floating riser card 57 relative to the root complex device of motherboard 50.

FIGS. 2A through 2F illustrate an example application of the dual-sided connector in which a fixed hardware component is a computer motherboard and a floating hardware component is an OCP card. FIG. 2A illustrates an example computer that includes a dual-sided connector for connecting a signal cable to a hardware component for signal transmission, according to certain implementations. In particular, FIG. 2A illustrates an example in which the dual-sided connector facilitates connecting to an OCP card, as described in greater detail below.

In certain implementations, the components of FIG. 2A may be disposed within a chassis of a computer 48. A motherboard 50 may be disposed within the chassis of computer 48, and a CPU may be securely mounted on motherboard 50.

In the example illustrated in FIG. 2A, the apparatus within the chassis of computer 48 may include a floating OCP slot 77 that includes a support structure 65, and the apparatus also includes a dual-sided connector 76. Floating OCP slot 77 is adapted to accommodate an OCP Add-in card 78. In certain implementations, OCP Add-in card 78 is a type of expansion card or adapter designed and built according to specifications and standards defined by the OCP.

OCP Add-in card 78 and dual-sided connector 76 may be supported in position within the chassis of computer 48 using support structure 65, which can be positioned at any distance away from, and in any orientation in relation to, motherboard 50. Support structure 65 may be a mechanical support structure, such as a tray, a plate, or the like. OCP Add-in card 78 and dual-sided connector 76 may be attached or coupled to support structure 65 to form floating OCP slot 77.

Floating OCP slot 77 allows the use of one or more cables (e.g., a PCIe cable 56) as the main interconnect to connect the root complex device of motherboard 50 of computer 48 to floating OCP slot 77, where the root complex device may be located some distance (and potentially a relatively significant distance) from floating OCP slot 77. Floating OCP slot 77 can be positioned at any distance away from, and in any orientation in relation to motherboard 50. In addition, PCIe cable 56 may have any desired length, and may be coupled to a first PCIe plug 54 (which also may be referred to subsequently as a connector) on a first end of PCIe cable 56, and a second PCIe plug 58 (which also may be referred to subsequently as a connector) on a second end of PCIe cable 56. First PCIe plug 54 may be plugged into a PCIe connector 52 (which also may be referred to subsequently as a slot or a socket) coupled to motherboard 50. Second PCIe plug 58 may be plugged into a first socket 84 of dual-sided connector 76.

Dual-sided connector 76 may include a housing 85 (shown subsequently in FIG. 2B), first socket 84 (shown subsequently in FIG. 2B) on a first side of housing 85, and a second socket 86 (shown subsequently in FIG. 2B) on a second side of housing 85. Dual-sided connector 76 also may be referred to as a signal transmission device. First socket 84 is adapted to receive second PCIe plug 58 inserted into first socket 84 of dual-sided connector 76. That is, first socket 84 is adapted to allow second PCIe plug 58 to be plugged into first socket 84 of dual-sided connector 76. Second socket 86 is adapted to receive an end portion of an OCP Add-in card 78 inserted into second socket 86 of dual-sided connector 76. That is, the second socket 86 is adapted to allow an OCP Add-in card 78 to be plugged into second socket 86 of dual-sided connector 76.

When second PCIe plug 58 is plugged into first socket 84 and OCP Add-in card 78 is plugged into second socket 86, dual-sided connector 76 allows the transmission of signals between OCP Add-in card 78 and motherboard 50. The signals may include data signals, control signals, power signals, and/or any other suitable type of signals. In certain implementations, more than one floating OCP slot 77 may be connected to motherboard 50 using respective PCIe cables 56. In such a case, more than one OCP Add-in card 78 may be connected to motherboard 50. Each OCP Add-in card 78 is connected to motherboard 50 using a corresponding dual-sided connector 76 and a corresponding PCIe cable 56, wherein OCP Add-in card 78 is plugged into second socket 86 of the corresponding dual-sided connector 76, and second PCIe plug 58 of the corresponding PCIe cable 56 is plugged into first socket 84 of the corresponding dual-sided connector 76.

FIG. 2B illustrates additional details of the example dual-sided connector 76 described with reference to FIG. 2A, according to certain implementations. Support structure 65 from FIG. 2A is omitted from FIG. 2B for purposes of clarity. Dual-sided connector 76 may include housing 85 (which also may be referred to subsequently as the body), first socket 84 (which may also be described subsequently as a receptacle) on a first side of housing 85, and second socket 86 (which may also be described subsequently as a receptacle) on a second side of housing 85, wherein the first side is on an opposite side of housing 85 as the second side of housing 85. First socket 84 may include a first opening 80, and second socket 86 may include a second opening 82. First socket 84 is adapted to allow second PCIe plug 58 to be inserted into first opening 80 of first socket 84, and second socket 86 is adapted to allow an end portion of OCP Add-in card 78 (e.g., an OCP card edge connector of OCP Add-in card 78) to be inserted into second opening 82 of second socket 86. First opening 80 and second opening 82 are adjacent to each other, and are interconnected with each other. In certain implementations, first opening 80 and second opening 82 form at least part of a continuous opening that also extends through housing 85 of dual-sided connector 76.

Dual-sided connector 76 may include contiguous metal contacts 88 (shown subsequently in FIG. 2C) that are configured to be in contact with a signal pad of second PCIe plug 58 when second PCIe plug 58 is plugged into first socket 84 of dual-sided connector 76. In addition, contiguous metal contacts 88 are configured to be in contact with a signal pad of the OCP card edge connector of OCP Add-in card 78 when OCP Add-in card 78 is plugged into second socket 86 of dual-sided connector 76. Each metal contact 88 therefore acts as a bridge between the two signal pads. Dual-sided connector 76 therefore allows signal transmission between OCP Add-in card 78 and PCIe cable 56.

Dual-sided connector 76 may include portions having different heights. For example, a first portion of dual-sided connector 76 that includes first socket 84 may have a third height H3. A second portion of the dual-sided connector 76 that includes second socket 86 may have a fourth height H4, wherein the height H3 is different from the height H4. In certain implementations, the height H4 is greater than the height H3.

FIGS. 2C-2E illustrate additional details of dual-sided connector 76 of FIGS. 2A and 2B, according to certain implementations. In particular, FIGS. 2C-2D illustrate a state of dual-sided connector 76 after second PCIe plug 58 is plugged into first opening 80 of first socket 84, and the OCP card edge connector of OCP Add-in card 78 is plugged into second opening 82 of second socket 86. FIG. 2E shows a top-down view of dual-sided connector 76 along a cross-section Y-Y that is shown in FIG. 2C. In FIGS. 2C-2E, support structure 65 (e.g., as shown in FIG. 2A) is omitted for purposes of clarity.

FIGS. 2C-2D show that dual-sided connector 76 may include contiguous metal contacts 88. Metal contacts 88 may include a conductive material (e.g., copper, copper alloy, or any other suitable conductive material) and may extend along a first surface of first socket 84 to along a corresponding first surface of second socket 86, and along a second surface of first socket 84 to along a corresponding second surface of second socket 86. In certain implementations, the first surface of first socket 84 is a top surface in first opening 80, and the first surface of second socket 86 is a top surface in second opening 82. In certain implementations, the second surface of first socket 84 is a bottom surface in first opening 80, and the second surface of second socket 86 is a bottom surface in second opening 82.

First opening 80 and second opening 82 form at least part of a continuous opening that also extends through housing 85 of dual-sided connector 76, and as such, each metal contact 88 that extends along the first surface of first socket 84 to along the corresponding first surface of second socket 86 also extends along a top surface of a first portion of the continuous opening that is disposed between first opening 80 and second opening 82. Additionally, each metal contact 88 that extends along the second surface of first socket 84 to along the corresponding second surface of second socket 86 also extends along a bottom surface of the first portion of the continuous opening that is disposed between first opening 80 and second opening 82.

Each metal contact 88 may be elongated, and may include a strip having a rectangular or cylindrical cross-section. In certain implementations, metal contacts 88 may be arranged to be flat. In certain implementations, metal contacts 88 may be arranged to have a zigzag form (e.g., as shown in FIGS. 2C and 2D) that includes multiple bends or turns in the metal, with first portions of each metal contact 88 being embedded in the walls of first socket 84, second socket 86, and housing 85. Second portions of each metal contact 88 may extend into first opening 80, second opening 82, or the first portion of the continuous opening that is disposed between first opening 80 and second opening 82. Second portions of each metal contact 88 that extend into first opening 80 may be adapted to make physical and electrical contact with a first signal pad 59 of second PCIe plug 58 when second PCIe plug 58 is plugged into first opening 80 of first socket 84. Second portions of each metal contact 88 that extend into second opening 82 may be adapted to make physical contact and electrical contact with a second signal pad 90 of the OCP card edge connector of OCP Add-in card 78, when OCP Add-in card 78 is plugged into second opening 82 of second socket 86.

Metal contacts 88 that extend along the first surface of first socket 84 to along the corresponding first surface of second socket 86 are adapted to be vertically above, and make physical and electrical contact with a top surface of a top portion of first signal pad 59 of second PCIe plug 58, and a top surface of a top portion of second signal pad 90 of the OCP card edge connector. Metal contacts 88 that extend along the second surface of first socket 84 to along the corresponding second surface of second socket 86 are adapted to be vertically below, and make physical and electrical contact with a bottom surface of a bottom portion of first signal pad 59 of second PCIe plug 58, and a bottom surface of a bottom portion of second signal pad 90 of the OCP card edge connector.

Metal contacts 88 being arranged to have the zigzag form (e.g., as shown in FIGS. 2C and 2D) that includes multiple bends or turns in the metal allow for a secure and reliable electrical connection between metal contacts 88, and first signal pad 59 and second signal pad 90. In addition, the multiple bends or turns in the metal are strategically positioned to ensure proper alignment and a snug fit of second PCIe plug 58 in first opening 80 of first socket 84, and the OCP card edge connector of OCP Add-in card 78 in second opening 82 of second socket 86. When second PCIe plug 58 is plugged into first socket 84, and the OCP card edge connector of OCP Add-in card 78 is plugged into second socket 86, dual-sided connector 76 allows the transmission of signals between OCP Add-in card 78 and motherboard 50 of computer 48. The signals may be transmitted between motherboard 50 and OCP Add-in card 78 through PCIe cable 56, first signal pad 59, metal contacts 88, and second signal pad 90.

In certain implementations, dual-sided connector 76 may include more than one of first sockets 84 on the first side of dual-sided connector 76. For example, FIG. 2E shows dual-sided connector 76 including first sockets 84 (e.g., two of first sockets 84). Dual-sided connector 76 also includes second socket 86, and housing 85 disposed between first sockets 84 and second socket 86. An edge of dual-sided connector 76 that is disposed on the first side (e.g., the first side including first sockets 84) of dual-sided connector 76 may have a third width W3. Second socket 86 is disposed on the second side of housing 85, wherein an edge of dual-sided connector 76 that is disposed on the second side of dual-sided connector 76 may have a fourth width W4. In certain implementations, the third width W3 is different from the fourth width W4. In certain implementations, the fourth width W4 is greater than the third width W3. As shown in FIG. 2E, each first socket 84 may be electrically connected to motherboard 50 by a corresponding PCIe cable 56, wherein each PCIe cable 56 is coupled to the respective first socket 84 by a respective second PCIe plug 58 that is plugged into the respective first socket 84.

Two of first sockets 84 are shown in FIG. 2E, wherein each first socket 84 may be designed to accommodate, as just one example, a PCIe x8 cable. Second socket 86 on the second side of dual-sided connector 76 may be designed to accommodate an OCP Add-in card, and may be designed to provide, just one example, sixteen individual PCIe lanes for signal transfer.

FIG. 2E also shows that each second PCIe plug 58 that is coupled to a PCIe cable 56 includes a first signal pad 59 that is electrically coupled to second signal pad 90 of OCP Add-in card 78 using a respective set of one or more metal contacts 88. First end portions of metal contacts 88 of the respective set of one or more metal contacts 88 align with and physically contact a first signal pad 59 of a respective second PCIe plug 58, when the respective second PCIe plug 58 is plugged into a respective first socket 84. Second end portions of metal contacts 88 of the respective set of one or more metal contacts 88 align with and physically contact second signal pad 90 of the OCP card edge connector of OCP Add-in card 78, when the OCP card edge connector of OCP Add-in card 78 is plugged into second socket 86. In this way, the transmission of signals between OCP Add-in card 78 and each PCIe cable 56 can take place using the respective set of one or more metal contacts 88.

The third width W3 of an edge of dual-sided connector 76 that is disposed on the first side of dual-sided connector 76 may be different from the fourth width W4 of an edge on dual-sided connector 76 that is disposed on the second side of dual-sided connector 76 (as seen in FIG. 2E). To accommodate for this variation between the third width W3 and the fourth width W4, the respective set of one or more metal contacts 88 that electrically connect second signal pad 90 to a respective first signal pad 59 may be disposed having different shapes (as seen in a top-down view) to ensure proper alignment of metal contacts 88, as well as to ensure correct electrical connection between second signal pad 90 and the respective first signal pad 59. One or more of metal contacts 88 may have an S-shape (e.g., as shown in FIG. 2E), an L-shape, or the like. In certain implementations, one or more of metal contacts 88 may be diagonal (e.g., disposed to be at an angle relative to the edge of dual-sided connector 76 that is disposed on the second side of dual-sided connector 76), or straight (e.g., disposed to be perpendicular to the edge of dual-sided connector 76 that is disposed on the second side of dual-sided connector 76).

FIG. 2F illustrates a perspective view of floating OCP slot 77 of FIG. 2A, according to certain implementations. Floating OCP slot 77 includes support structure 65, and dual-sided connector 76. Floating OCP slot 77 is adapted to accommodate an OCP Add-in card 78. OCP Add-in card 78 and dual-sided connector 76 may be supported in position within the chassis of computer 48 using support structure 65. OCP Add-in card 78 and dual-sided connector 76 may be attached or coupled to support structure 65 to form floating OCP slot 77, which can be positioned at any distance away from, and in any orientation in relation to motherboard 50 of the computer 48. FIG. 2F also shows second PCIe plugs 58 of respective PCIe cables 56 that can be plugged into respective first sockets 84 of dual-sided connector 76. The OCP card edge connector of OCP Add-in card 78 is also shown, which can be plugged into second socket 86 of dual-sided connector 76. When second PCIe plugs 58 of the respective PCIe cables 56 are plugged into the respective first sockets 84 of dual-sided connector 76, and when the OCP card edge connector of OCP Add-in card 78 is plugged into second socket 86 of dual-sided connector 76, transmission of signals between OCP Add-in card 78 and motherboard 50 of computer 48 can take place using dual-sided connector 76.

Certain implementations may provide none, some, or all of the following technical advantages. These and other potential technical advantages may be described elsewhere in this disclosure, or may otherwise be readily apparent to those skilled in the art based on this disclosure.

In certain implementations, dual-sided connector 76 and OCP Add-in card 78 may be attached to support structure 65 to support dual-sided connector 76 and OCP Add-in card 78, and to hold them in position. The combination of support structure 65 and dual-sided connector 76 can be referred to as a floating OCP slot 77.

Dual-sided connector 76 may allow for the transmission of signals between OCP Add-in card 78 and motherboard 50. Dual-sided connector 76 includes contiguous metal contacts 88 that are configured to be in contact with first signal pads 59 of respective second PCIe plugs 58 when the respective second PCIe plugs 58 are plugged into respective first sockets 84 of dual-sided connector 76. In addition, contiguous metal contacts 88 are configured to be in contact with second signal pad 90 of OCP card edge connector of OCP Add-in card 78 when OCP Add-in card 78 is plugged into second socket 86 of dual-sided connector 76. One or more of metal contacts 88 therefore may allow the transmission of signals between first signal pads 59 and second signal pad 90.

Certain implementations may allow PCIe cable 56 to be removably attached to an OCP slot connector, as PCIe cable 56 may be removably attached to dual-sided connector 76 through engagement of second PCIe plug 58 and first socket 84 on the first side of dual-sided connector 76. Relative to a solution that would fixedly attach an end of a PCIe cable to an OCP slot connector within the chassis of a computer, using dual-sided connector 76 may reduce manufacturing and assembly costs, permit replacement of PCIe cable and/or dual-sided connector 76 individually, and/or increase installation flexibility. Furthermore, in certain implementations, dual-sided connector 76 may provide one or more of these advantages while still providing for adequate or even improved bus speeds and signal quality.

For example, both PCIe cable 56 and floating OCP slot 77 may be separable from each other by simply unplugging PCIe cable 56 from dual-sided connector 76 (e.g., by removing second PCIe plug 58 from first socket 84 of dual-sided connector 76). This may allow replacement of PCIe cable 56 and/or floating OCP slot 77 (e.g., in case of damage or electrical problems or for any other reason) without replacing both PCIe cable 56 and floating OCP slot 77, which may reduce costs relative to other potential solutions. In certain implementations, dual-sided connector 76 may improve signal transmission quality due to a reduced number of impedance discontinuities such as from connector pin pads and cable wires. In certain implementations, depending on what may be appropriate for a given implementation, different lengths of PCIe cable 56 may be utilized to connect motherboard 50 of computer 48 to dual-sided connector 76, allowing for flexibility in the positioning of floating OCP slot 77 relative to the root complex device of motherboard 50.

FIG. 3 illustrates an example method 100 for a dual-sided connector for connecting a signal cable to a hardware component for signal transmission, according to certain implementations.

In certain implementations, method 100 may be used in conjunction with a dual-sided connector 62 (e.g., of the type illustrated in and described with respect to FIGS. 1A, 1B, and 1C-1E) for removably connecting a PCIe cable 56 to a first socket 66 of dual-sided connector 62 and removably coupling a PCIe card (e.g., PCIe Add-in card 64) to a second socket 68 of dual-sided connector 62. Using method 100 in connection with a dual-sided connector 62 may allow transmission of signals between motherboard 50 and PCIe Add-in card 64. In such an example, the hardware component could be a PCIe card (e.g., PCIe Add-in card 64), for example.

In certain implementations, method 100 may be used in conjunction with a dual-sided connector 76 (e.g., of the type illustrated in and described with respect to FIGS. 2A, 2B, 2C-2E, and 2F) for removably connecting a PCIe cable 56 to a first socket 84 of dual-sided connector 76 and removably coupling an OCP card (e.g., OCP Add-in card 78) to a second socket 86 of dual-sided connector 76. Using method 100 in connection with a dual-sided connector 76 may allow transmission of signals between motherboard 50 and OCP Add-in card 78. In such an example, the hardware component could be an OCP card (e.g., OCP Add-in card 78), for example.

In step 102, a dual-sided connector may be mounted to a support structure.

For example, in the case of dual-sided connector 62, dual-sided connector 62 may be mounted to a riser card body 60 to form floating riser card 57. Dual-sided connector 62 may be mounted such that dual-sided connector 62 is supported by and extends through riser card body 60. Dual-sided connector 62 may include a housing 67, a first socket 66 on a first side of housing 67, a second socket 68 on a second side of housing 67, and metal contacts 74 disposed within dual-sided connector 62 and extending from first socket 66 to second socket 68.

As another example, in the case of dual-sided connector 76, dual-sided connector 76 may be mounted to a support structure 65 to form floating OCP slot 77. Dual-sided connector 76 may be mounted such that dual-sided connector 76 is supported in position by support structure 65. Dual-sided connector 76 may include a housing 85, a first socket 84 on a first side of housing 85, a second socket 86 on a second side of housing 85, and metal contacts 88 disposed within dual-sided connector 76 and extending from first socket 84 to second socket 86.

In step 104, a first signal cable connector of a first signal cable may be plugged into a first socket of the dual-sided connector. In certain implementations, the first signal cable may be a PCIe cable 56 having a first PCIe plug 54 that is connected to (or to be connected to) a PCIe connector 52, which may be located on a motherboard 50 of a computer.

For example, in the case of dual-sided connector 62, a second PCIe plug 58 may be plugged into first socket 66. Second PCIe plug 58 may be coupled to a first end of PCIe cable 56, and a second end of PCIe cable 56 may be coupled to first PCIe plug 54. First PCIe plug 54 may be configured to be connected to a motherboard 50 of a computer 48. After plugging second PCIe plug 58 into first socket 66, metal contacts 74 of dual-sided connector 62 may be in physical contact with first signal pad 59 of second PCIe plug 58.

As another example, in the case of dual-sided connector 76, a second PCIe plug 58 may be plugged into first socket 84. Second PCIe plug 58 may be coupled to a first end of PCIe cable 56, and a second end of PCIe cable 56 may be coupled to first PCIe plug 54. First PCIe plug 54 may be configured to be connected to a motherboard 50 of a computer 48. After plugging second PCIe plug 58 into first socket 84, metal contacts 88 of dual-sided connector 76 may be in physical contact with first signal pad 59 of second PCIe plug 58.

In step 106, a hardware component may be plugged into a second socket of the dual-sided connector.

For example, in the case of dual-sided connector 62, PCIe Add-in card 64 is plugged into second socket 68. After plugging PCIe Add-in card 64 into second socket 68, metal contacts 74 of dual-sided connector 62 may be in physical contact with second signal pad 63 of PCIe Add-in card 64.

As another example, in the case of dual-sided connector 76, OCP Add-in card 78 is plugged into second socket 86. After plugging OCP Add-in card 78 into second socket 86, metal contacts 88 of dual-sided connector 76 may be in physical contact with second signal pad 90 of OCP Add-in card 78.

In step 108, signals may be transmitted between motherboard 50 of computer 48 and a hardware component via the dual-sided connector. In certain implementations, signals may be transmitted between motherboard 50 of computer 48 and a hardware component using metal contacts of the dual-sided connector.

For example, in the case of dual-sided connector 62, signals may be transmitted between motherboard 50 and PCIe Add-in card 64 using first PCIe plug 54, PCIe cable 56, second PCIe plug 58, first signal pad 59, metal contacts 74, and second signal pad 63.

As another example, in the case of dual-sided connector 76, signals may be transmitted between motherboard 50 and OCP Add-in card 78 using first PCIe plug 54, PCIe cable 56, second PCIe plug 58, first signal pad 59, metal contacts 88, and second signal pad 90.

It should be understood that the systems and methods described in this disclosure may be combined in any suitable manner, whether for either an Add-in PCIe, an OCP card, or another suitable type of floating hardware component. For example, a computer system may include a dual-sided connector for connecting a floating PCIe riser card, a floating OCP card, or another suitable floating hardware component, alone or in any suitable combination, on the same computer system.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A connector, comprising:
a housing;
a first socket on a first side of the housing, the first socket configured to receive a first signal cable connector inserted into the first socket;
a second socket on a second side of the housing, the second socket configured to receive an end portion of a hardware component inserted into the second socket, wherein the first socket and the second socket are adjacent to each other, the first socket and the second socket having openings that are interconnected with each other;
a first metal contact extending along a first surface of the first socket to along a corresponding first surface of the second socket; and
a second metal contact extending along a second surface of the first socket to along a corresponding second surface of the second socket.

2. The connector of claim 1, wherein the first metal contact is configured to be in physical contact with a first signal pad of the first signal cable connector in the first socket and a second signal pad of the hardware component in the second socket.

3. The connector of claim 2, wherein the first metal contact is configured to be to:
a first side of the first signal cable connector such that the first signal pad is between the first metal contact and a first surface of the first signal cable connector to the first side of the first signal cable connector; and
a first side of the hardware component such that the second signal pad is between the first metal contact and a first surface of the hardware component to the first side of the hardware component.

4. The connector of claim 1, wherein the second metal contact is configured to be in physical contact with a third signal pad of the first signal cable connector and a fourth signal pad of the hardware component.

5. The connector of claim 4, wherein the second metal contact is configured to be to:
a second side of the first signal cable connector such that the third signal pad is between the second metal contact and a second surface of the first signal cable connector to the second side of the first signal cable connector, the first side of the first signal cable connector opposing the second side of the first signal cable connector; and
a second side of the hardware component such that the fourth signal pad is between the second metal contact and a second surface of the hardware component to the second side of the hardware component, the first side of the hardware component opposing the second side of the hardware component.

6. The connector of claim 1, further comprising a third socket on the first side of the housing, the third socket configured to receive a second signal cable connector inserted into the third socket.

7. The connector of claim 6, further comprising a third metal contact extending along a first surface of the third socket to along a corresponding third surface of the second socket, wherein the third metal contact is configured to be in physical contact with a fifth signal pad of the second signal cable connector in the third socket.

8. The connector of claim 1, wherein the hardware component comprises:
a peripheral component interconnect express (PCIe) card; or
an open compute project (OCP) card.

9. An apparatus, comprising:
a support structure; and
a dual-sided connector coupled to the support structure, the dual-sided connector comprising:
a housing;
a first socket on a first side of the dual-sided connector, the first socket configured to receive a first PCIe cable connector inserted into the first socket;
a second socket on a second side of the dual-sided connector, the second socket configured to receive an end portion of a hardware component inserted into the second socket; and
a plurality of first metal contacts disposed within the dual-sided connector and extending from the first socket to the second socket, wherein each first metal contact is configured to be in physical contact with a first signal pad of the first PCIe cable connector and a second signal pad of the hardware component.

10. The apparatus of claim 9, wherein the support structure comprises a riser card body.

11. The apparatus of claim 9, wherein the support structure comprises a tray or a plate.

12. The apparatus of claim 9, wherein:
the first socket comprises a first opening;
the second socket comprises a second opening; and
the first opening and the second opening form at least a portion of a continuous opening through the housing of the dual-sided connector.

13. The apparatus of claim 9, wherein the hardware component comprises:
a peripheral component interconnect express (PCIe) card; or
an open compute project (OCP) card.

14. The apparatus of claim 9, further comprising a third socket on the first side of the dual-sided connector adjacent to the first socket, the third socket configured to allow a second PCIe cable connector to be inserted into the third socket.

15. The apparatus of claim 14, further comprising a plurality of second metal contacts disposed within the dual-sided connector and extending from the third socket to the second socket, wherein each second metal contact is configured to be in physical contact with a third signal pad of the second PCIe cable connector and the second signal pad of the hardware component.

16. The apparatus of claim 9, wherein at least one first metal contact of the plurality of first metal contacts has an S-shape or an L-shape when seen in a top-down view.

17. A method comprising:
mounting a dual-sided connector on a support structure, the dual-sided connector comprising:
a housing;
a first socket on a first side of the housing;
a second socket on a second side of the housing; and
a plurality of metal contacts disposed within the dual-sided connector and extending from the first socket to the second socket;
plugging a first signal cable connector into the first socket, the first signal cable connector coupled to a first end of a signal transmission cable, wherein:
a second end of the signal transmission cable is coupled to a second signal cable connector that is configured to be connected to a motherboard of a computer; and
after plugging the first signal cable connector into the first socket, the plurality of metal contacts are in physical contact with a first signal pad of the first signal cable connector; and
plugging a hardware component into the second socket, wherein after plugging the hardware component into the second socket, the plurality of metal contacts are in physical contact with a second signal pad of the hardware component.

18. The method of claim 17, further comprising transmitting signals between the motherboard of the computer and the hardware component using the plurality of metal contacts.

19. The method of claim 17, wherein:
the support structure comprises a riser card body; and
the dual-sided connector extends through the riser card body.

20. The method of claim 17, wherein the support structure comprises a tray or a plate.
